(19) United States
(12) Patent Application Publication
(10) Pub. No.: US 2010/0042434 A1
(43) Pub. Date: Feb. 18, 2010

(54) SYSTEM AND METHOD FOR DISCOVERING INFORMATION IN MEDICAL IMAGE DATABASE

(75) Inventors: Hui Luo, Pittsford, NY (US); Jacquelyn S. Ellinwood, Rochester, NY (US); David H. Foos, Webster, NY (US)

Correspondence Address: Carestream Health, Inc., 150 Verona Street, Rochester, NY, 14608, US

(73) Assignee: Carestream Health, Inc.

(21) Appl. No.: 12/190,613

(22) Filed: Aug. 13, 2008

(51) Int. Cl. G06F 19/00

(52) U.S. Cl. 705/3

(57) ABSTRACT

A system for obtaining information related to diagnostic imaging performance at a site has a user instruction interface for obtaining an operator request for information related to image quality for stored diagnostic images. A data processor is in communication with at least one database of stored patient diagnostic images and is programmed with instructions for retrieving one or more patient diagnostic images from the database of patient diagnostic images according to the operator request from the user instruction interface, for analyzing the image quality of the one or more patient diagnostic images as specified in the operator request, and for providing at least output information about the image quality analysis to a data mining engine. The data mining engine is programmed with instructions to process the output information that is obtained from the data processor and to provide information related to image quality according to the output information.

### FIELD OF THE INVENTION

The present invention relates generally to accessing information stored in medical databases and in particular to data mining techniques for obtaining information and knowledge stored in medical image databases.

### BACKGROUND OF THE INVENTION

Medical images play a role in medical diagnosis, therapy, surgical treatments and medical training, as well as in research. With the rapid advances in digital imaging modalities such as computed radiography (CR), digital radiography (DR), computed tomography (CT) and magnetic resonance imaging (MRI), for example, the number of digital medical images obtained each year by hospitals, clinics, and other health facilities has grown tremendously. Today, an average US hospital with 600 beds generates over one million images per year, and this number is expected to grow significantly in the near future. To efficiently manage these large image files and the associated diagnosis reports, Picture Archiving And Communications Systems (PACS), with images stored in Digital Imaging and Communications in Medicine (DICOM) format, and Radiology Information System (RIS) have been widely adopted by hospitals.

To date, the focus of attention in development of systems and utilities to meet the need for image management has largely been directed to archival of patient images and other pertinent patient records. PACS, RIS, and other information storage systems used by hospitals store the collection of a patient's electronic data and images obtained and used for patient diagnosis. Once diagnosis is complete, the data stored in these databases is rarely retrieved for other purposes. Occasionally, an image may be retrieved from the database and viewed for historical interest or in order to track a particular disease pattern. Once an image is stored, however, there is generally little likelihood of its data being utilized for any other purpose.

In addition to its diagnostic data content, the image database as a whole also contains other “hidden” information that, although not directly associated with diagnosis for a particular patient, may have value related to overall health-care quality and performance of the hospital or other imaging facility, including information of value to hospital management, medical education and staff training, and research. Effective use of this information could provide significant benefits, improving the efficiency of the hospital facility and enhancing the quality of health-care delivery. In conventional practice, however, no attempt is made to systematically seek out such information from the vast storage banks of patient image data that is archived by hospitals and other health facilities.

Of particular interest to radiology departments, for example, is image quality. In day-to-day digital radiographic acquisition, technologists perform some level of visual quality assurance (QA) on captured radiographic images. On a viewing console, each image is evaluated in order to check that it is free from defects that might impact diagnostic interpretation. Once an image is acceptable, it is released to a PACS for diagnostic interpretation by a radiologist. Images that, upon inspection, are found to have defects, such as clipped anatomy, over- or under-exposure, motion blur, or other defect, are generally rejected and retaken. In many environments, technologists perform this review process manually. Their ability to detect defects and exercise proper judgement can be affected by factors such as difficulty in viewing images at the proper resolution and under the best possible conditions, demanding workloads, and varying levels of training and experience. One or more of these factors can lead to defect oversight, so that images having marginal diagnostic quality at best may be stored in the PACS for use by the radiologist, without any short- or long-term correction taken. Diagnosis often suffers accordingly. Retaking the radiographic image, although it may be best for diagnostic accuracy, is highly undesirable for the patient and for efficient administration for a number of reasons. This activity requires rescheduling complications, cost, and delays, and introduces other administrative problems. As a result, some compromises can be made related to image quality, which can include accepting images of disappointing quality in order to avoid huge disruptions in workflow, for example.

Administrators and management personnel recognize the general types of problems that impact the effectiveness and efficiency of their imaging facility. Without extensive effort, however, administrators and management personnel find it very difficult to uncover specific root causes of imaging problems that result in poor image quality and the need for retakes. Some types of problems, for example, can be alleviated by proper training of technologists if individual weaknesses can be more closely identified. Other problems can be addressed more appropriately by changes of practice in the imaging department. Still other types of chronic imaging problems are not skill- or setup-dependent, but may be more closely related to condition or age of equipment or to imaging conditions in general, some of which difficulties may have straightforward solutions. Discovering these types of root causes, given the huge mass of data that is available, is a daunting task for effective imaging facility administration.

Data mining techniques have been applied to the problems of patient diagnosis, for extracting patient data from multiple storage systems, as evidenced, for example, in U.S. Patent Application No. 2006/0265253 entitled “Patient Data Mining Improvements” by Rao et al. Solutions such as that proposed in the Rao et al. '5253 disclosure form a structured Computerized Patient Record (CRD) or similar data structure by collecting a composite set of information about the patient from two or more databases, such as billing and insurance databases, image storage repositories, and physician databases. A number of similar solutions have been proposed for mining the PACS database for patient data. For example, Stewart et. al, (“Computed radiography dose data mining and surveillance as an ongoing quality assurance improvement process”, American Journal of Roentgenology., Jul. 1, 2007; 189(1): 7-11), shows that mining PACS image data can be useful in reducing patient radiation dose and inter-examination dose variance. Anticipated benefits from such solutions include improved patient diagnosis with better access to all of the available patient records, reduced likelihood of duplication in imaging or treatment of patients, and improved overall efficiency in patient handling and billing. While such data mining techniques may be useful for obtaining comprehensive patient treatment data that is, of necessity, stored in various related systems, however, this diagnostic information relates only to each single patient, rather than to the performance of the imaging facility overall.

Thus, although data mining methods have been employed for obtaining information from different systems to aid in diagnosis of the individual patient, attention has not been paid to the particular difficulties and potential advantages of data mining techniques for improved health care administration, particularly for improving image quality at a hospital or other diagnostic imaging site.

### SUMMARY OF THE INVENTION

It is an object of the present invention to address the shortfalls of existing data mining approaches for medical images and information and to advance the art of healthcare administration and delivery thereby. With this object in mind, the present invention provides a system for obtaining information related to diagnostic imaging performance at a site, the system comprising: a user instruction interface for obtaining an operator request for information related to image quality for stored diagnostic images; and a data processor that is in communication with at least one database of stored patient diagnostic images and that is programmed with instructions for retrieving one or more patient diagnostic images from the at least one database of patient diagnostic images according to the operator request from the user instruction interface, for analyzing the image quality of the one or more patient diagnostic images as specified in the operator request, and for providing at least output information about the image quality analysis to a data mining engine, wherein the data mining engine is programmed with instructions to process the output information that is obtained from the data processor and to provide information related to image quality according to the output information.

It is a feature of the present invention that it employs data mining to obtain and assess image data for quality and performance information about the imaging facility itself and to obtain other non-image patient information.

An advantage provided by embodiments of the system of the present invention is that administrative information that spans multiple patient records, including patient images, can be obtained and analyzed for improving imaging performance.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

The foregoing and other objects, features, and advantages of the invention will be apparent from the following more particular description of embodiments of the invention, as illustrated in the accompanying drawings.

FIG. 1 illustrates a system architecture for an embodiment of the present invention.

FIG. 2 is a block diagram showing the format of a data source record.

FIG. 3 shows an example of the data processing engine used for image quality evaluation.

FIG. 4 shows another example of the data processing engine used for image diagnosis.

FIG. 5 shows types and uses for output of the query engine.

FIGS. 6A-6G show portions of a graphical user interface for entry of user instructions in one embodiment of the present invention.

FIG. 7 shows a plan view of an example report of cumulative exposure averages.

FIG. 8 is a plan view showing a portion of an exemplary output report on technician performance.

FIG. 9 is a plan view showing a portion of an exemplary output report on patient exposure conditions; and

FIG. 10 is a plan view showing a portion of an exemplary output report on equipment performance.

### DETAILED DESCRIPTION OF THE INVENTION

The following is a detailed description of the preferred embodiments of the invention, reference being made to the drawings in which the same reference numerals identify the same elements of structure in each of the several figures.

In the context of the present disclosure, the term “engine” has the meaning generally understood in computer systems design, that is, indicating a hardware or software component, or interacting system of hardware and software components, capable of executing programmed instructions.

As noted above, medical images are generally stored in the Digital Imaging And Communications In Medicine (DICOM) format in the PACS database. The DICOM format provides a standard mechanism for handling, storing, printing and transmitting information related to medical images. The DICOM data structure relates not only to image data, but also to non-image data that is acquired during image capture, such as identification of body part and projection view, information on patient radiation dose, and technologist identifier, as well as to other exposure-related parameters.

Unlike the various types of conventional data mining applications that extract information related to an individual patient, embodiments of the present invention address the need for obtaining information from the PACS database and other medical databases that relates to the administration of health care, including the operation of health imaging facilities. Using the system and methods of the present invention, information can be obtained from different medical image and other databases to support functions such as performance assessment, training and education, and administrative functions, and to track trends in imaging parameters for improving how the health care imaging facility operates and for improving the efficiency of its imaging operations. Obtaining this type of overall administrative function requires novel approaches to the data mining problem and provides potential benefits for administrative and training personnel directed toward improving overall health-care delivery.

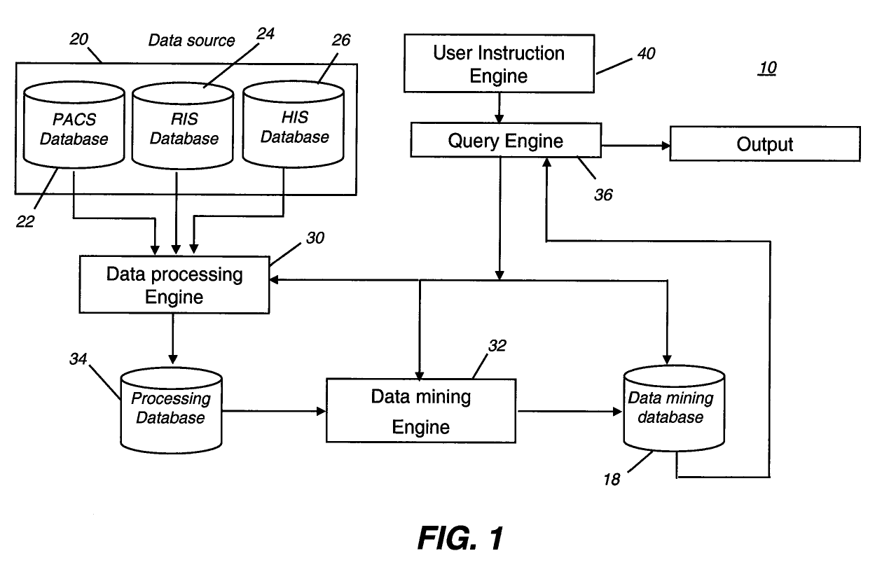

The block diagram of FIG. 1 illustrates a system architecture for a medical information system 10 in which various embodiments of the present invention may operate. Of particular interest relative to embodiments of the present invention are the following major components: (1) a data source 20; (2) a data processing engine 30; (3) a data mining engine 32; (4) a query engine 36; and (5) a user instruction engine 40. Each of these components is described in more detail subsequently.

### Data Source 20

A data source communicates with and provides access to data that is stored in different databases. In accordance with one embodiment of the present invention, the data source may contain some combination of Picture Archive And Communication System (PACS) databases 22, Radiology Information System (RIS) databases 24, and Hospital Information System (HIS) databases 26, as well as other data storage facilities. PACS database 22 stores and manages all images acquired in the radiology department for image diagnosis. These images are stored in DICOM format, to facilitate image communication and display. RIS database 24 provides information about radiology operation including patient registration, examination scheduling, diagnosis report, and other examination information. HIS database 26 is an integrated information system designed to manage the administrative, financial, and clinical aspects of a hospital. HIS database 26 provides detailed information related to the patient record, such as patient medical history, clinic diagnosis, and lab test data.

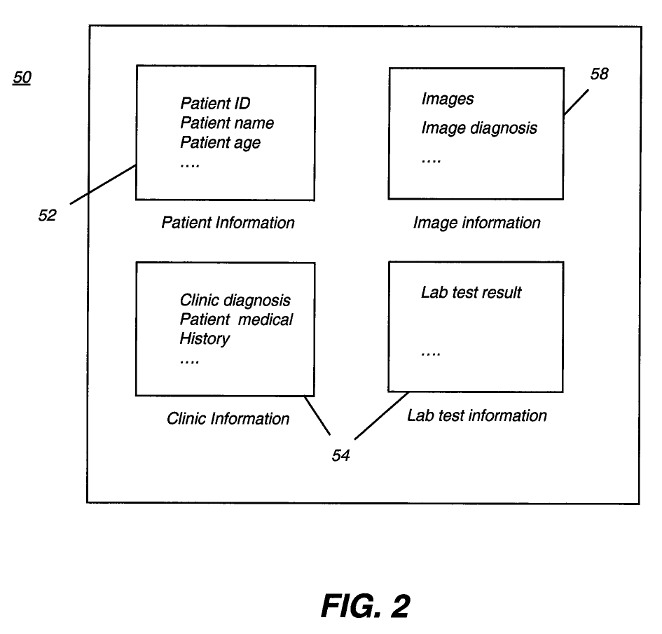

FIG. 2 shows an example format of one or more source records 50 provided by data source 20 in one embodiment. The data provided may include a patient identification field 52, one or more clinical test fields 54, a medical diagnosis field (not shown), and an image diagnosis field 58. According to an embodiment of the present invention, the databases in data source 20 may transmit source records on a fixed or periodic basis, such as one time per week, or once a month, or on a variable basis, for example, after a given amount of data is accumulated.

### Data Processing Engine 30

Data mining processes of the present invention apply image analysis logic to images stored in PACS database 22 or other database, extracting information that is of interest for evaluating image quality trends and the imaging processing operations and practices used to obtain images at a facility. By comparison with conventional data mining functions that attempt to extract information from the database that helps to diagnose an individual patient, the data mining functions of embodiments of the present invention can be considered as extracting information that helps to “diagnose” the effectiveness of the diagnostic imaging facility itself. To do this, embodiments of the present invention apply one or more image analysis functions to multiple images that are archived in the database, including images from different patients. The process and statistical data that is thus gathered then provides a basis of knowledge about how images have been obtained, wherein this knowledge is gained from analysis of the images themselves.

To provide this function using the system of FIG. 1, data processing engine 30, according to programmed instructions, receives and processes the data from data source 20 per instructions from query engine 36 and places the results into a processing database 34. The performance of the processing task is determined by user instructions, obtained by user instruction engine 40, that specify the information in which users are interested. Based on user interest, different processing methods are performed to meet different users' information queries. For example, supervisory and administrative staff in the radiology department may wish to correlate the image quality of images in the imaging department to the technologist identification, in order to assess the performance of individual technologists. For this purpose, data processing engine 30 is used to detect image problems using any of a number of image processing modules.

Some examples of problems or image defects that can be detected by image processing include:

1) the diagnosis-relevant anatomy is clipped or partially clipped in the image, which influences image diagnosis;

2) the patient moved during image capture which caused image blur;

3) unexpected artifacts appear in the image, obscuring or partially obscuring a region of interest and possibly preventing diagnosis;

4) the image was captured at an inappropriate exposure, which may result in noise, speckle, or other undesired problems in image display quality; and

5) the image lacks the proper marker information (such as for laterality).

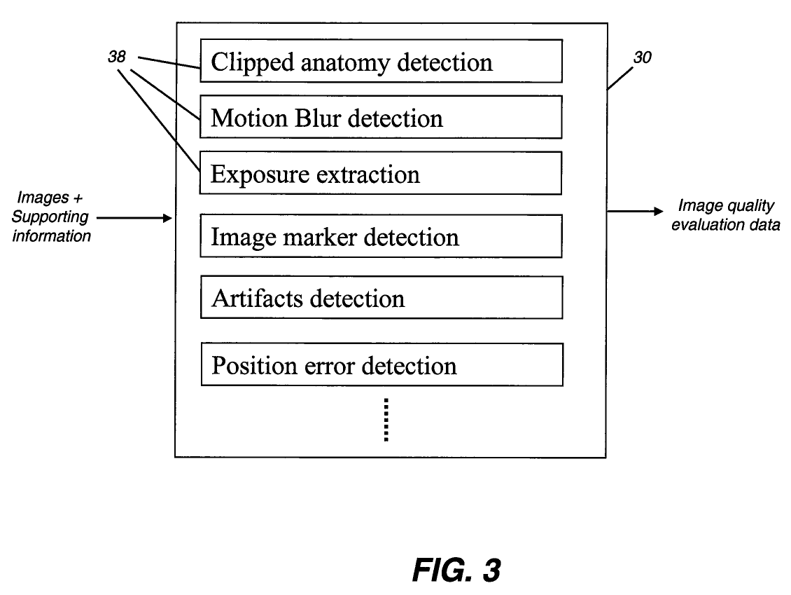

The block diagram of FIG. 3 shows functional components for programming instructions stored and executed by data processing engine 30 in one embodiment, designed for detecting image defects. The input of the data processing engine is an image and any support information about the image that can be extracted from RIS database 24 or HIS database 26. The output of engine 30 is a set of image quality evaluation data. This data can be a probability indicating the severity of a specific image defect, or a set of features detected by the processing engine used to evaluate the severity of the defect.

As illustrated in FIG. 3, data processing engine 30 includes a number of specialized modules 38, such as programmed software routines, for detecting various types of image quality problems from patient images according to analysis of image data. The detection of image defects can be accomplished using any of a number of suitable methods known to those skilled in the art. For detecting clipped anatomy, for example, one suitable method is disclosed in commonly assigned U.S. Ser. No. 11/834,222 filed on Aug. 6, 2007 by Luo et al. entitled METHOD FOR DETECTING CLIPPED ANATOMY IN MEDICAL IMAGES. A suitable method for detecting motion blur in medical images is disclosed in commonly assigned U.S. Ser. No. 11/834,304 filed on Aug. 6, 2007 by Luo et al. entitled METHOD FOR DETECTING ANATOMICAL MOTION BLUR IN DIAGNOSTIC IMAGES. Exposure extraction obtains the exposure level used for capturing each type of image. Other automated image analysis software detects image markers, speckle and a range of other image artifacts, or position errors. Still other types of specialized modules 38 could be used for detecting problems or obtaining information related to patient images such as tube placement for endo-tracheal (ET) tubes, feeding (FT) tubes, nasogastric tubes (NGT or NT) or other types of tubes. It can be appreciated that any number of appropriate methods for detection of imaging artifacts can be employed by data processing engine 30 within the scope of the present invention.

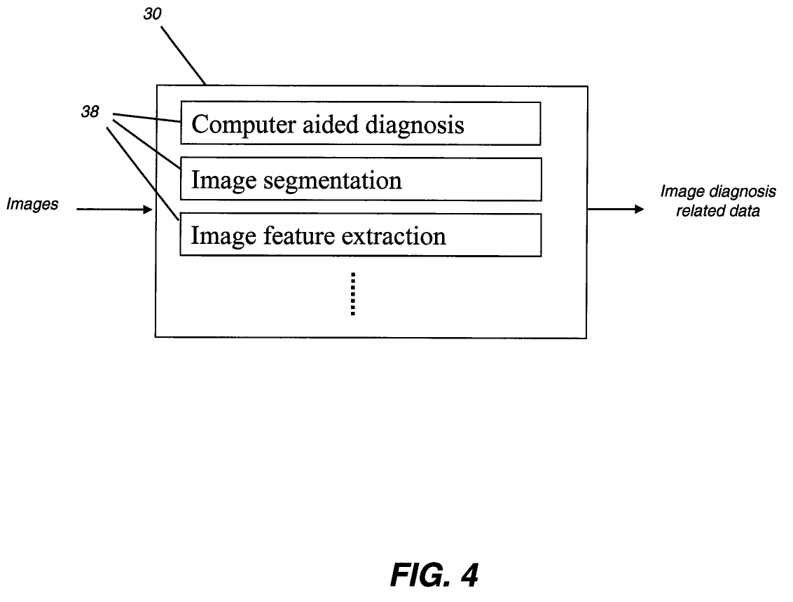

Alternately, diagnostic data can be obtained by data processing engine 30, as shown in the block diagram of FIG. 4. This type of function can be valuable to radiologists who are interested in finding images that are similar or relevant to a current study, such as to assist in diagnosis or training. In one embodiment of the present invention, data processing engine 30 performs image analysis that facilitates image retrieval. Data processing engine 30 can include specialized modules 38 for computer-aided detection or diagnosis, image segmentation, or feature extraction methods, as shown in FIG. 4. These image processing methods extract useful information or features for image analysis and comparison.

### Data Mining Engine 32

Referring again to the system of FIG. 1, data mining engine 32, operating upon programmed instructions, extracts the information or discovers the hidden patterns or relationships in the data processed per instruction from query engine 36 and places its results in a data mining database 18. The information, pattern, or relationship provided by data mining engine 32 relates to what a user seeks, according to instructions provided from user instruction engine 40. This information may be previously unknown, and may have the potential of being very useful. In one embodiment of data mining, all possible queries from various users are collected and analyzed. The information that relates to the queries is then grouped. Based on the nature of the information, data mining engine 32 can extend the data attributes, create new attributes, and detect data correlated relationships.

Regarding image quality assurance, data mining engine 32 may be used to provide the means for supervisory and administrative staff to develop a better understanding of the image quality within the imaging department, identify existing problems or limitations, and search for possible solutions. According to one embodiment of the present invention, data mining engine 32 can generate a summary that supervisors or administrative staffs can use to systematically review the various performance profiles of technologists, radiologists, and clinicians, for example. It is recognized that technologist performance is a component of image quality assurance. Data mining engine 32 can be used to evaluate the performance of an individual technologist by generating a profile of defect images attributed to that technologist, including image dose trends and other image quality-related information. This information can then be further studied to pinpoint the skill strength or weakness of technologist practices, and help supervisors to plan an effective educational and training plan for the individual technologist if needed.

In another embodiment of the present invention, data mining engine 32 can also be used as an inference engine to discover or derive information in the data extracted from multiple data sources. For example, regarding image quality assurance, data processing engine 30 may detect an artifact in a chest image. However the artifact may not be located in the diagnosis interested region, which can be derived from examination report in RIS; in such event, the existing artifact would not affect image diagnosis. Thus, even with a detected artifact, an image may not be considered as having a defect, and its image quality may be still be considered suitable for image diagnosis. In this case, data mining engine 32 takes into account the support information from RIS or HIS databases 24 and 26 to determine the diagnosis interest regions in the image. Then, by combining the image-data-processed results with the diagnosis interest region, data mining engine 32 assesses the existence or severity of defects and outputs an evaluation score.

Data mining engine 32 can perform trend analysis and predict a possible problem using a domain knowledge-base related to the problem of interest. For example, data mining engine 32 can be designed to monitor the cumulative radiation exposure of patients, and to analyze radiation dose trends for an image site. If necessary, a signal from data mining engine 32 can promptly alert practitioners to a recurring high-dose problem and suggest appropriate solutions. In such a case, the output of data mining engine 32 would be an indicator or value indicative of the severity of the problem.

In another embodiment of the present invention, data mining engine 32 is employed to discover frequently occurring patterns, associations, and correlations among data elements provided from data source 20. For example, image quality relative to x-ray technique settings can be analyzed for stored images. As another example, the correlation between image motion blur and type of image can also be analyzed. It is known, for example, that this image artifact occurs primarily in examinations that require longer exposure times, such as chest lateral and lumbar spine exams. Motion blur can result from inability of the patient to hold still or may be due to involuntary factors, such as heart-beat and respiration. Data mining engine 32 can be used to study patterns and to analyze correlations between events and image quality such as these represent. Information obtained from this analysis can then be used to help improve training and use of equipment accordingly.

The inference method used in data mining engine 32 may include or interface to a Bayesian-type inference engine or other self-learning methods such as neural network, support vector machine, or other statistical or logical engine, application, or resource.

In the systems embodiment of FIG. 1, any new attributes, relationship or summary created during data mining, along with selected data from the processed database or support information from other data sources, are used to build data mining database 18 or other data storage entity. The creation, maintenance, and extension of data attributes and data relationships in data mining database 18 can be both hierarchical and multidimensional. These data are ultimately made available for searching, modeling, and other purposes by end users, in order to enhance the power and efficiency of end user analysis.

Non-image data elements, along with the image data, can potentially provide an assessment of image quality for the diagnostic images. In addition, some of the non-image data, when extracted and combined over a large number of images, can provide information on data trends that is helpful to the radiology staff, such as for developing a better understanding of its operations. For example, during image capture, the patient exposure dose is directly associated with the technique practices (e.g. kVp, mA, exposure time, mAs, and source-to-detector distance). For different exam types (i.e., body part and projection), different technique practices are used. Data mining engine 32 can be used to analyze the association between the exposure dose and technique practices of each exam type and, based on further data related to image quality for images of a particular type, can provide information on the optimal technique and guidance for image capture. This would not only provide information related to cumulative exposure and exposure-related trends during a period of time, thereby providing data that can help to efficiently reduce patient radiation, but can also provide information that can be directly used to improve image quality under various conditions. In a particular study, or series of images for a patient in the same session, a suitable exposure technique can be selected based on this data.

### Query Engine 36

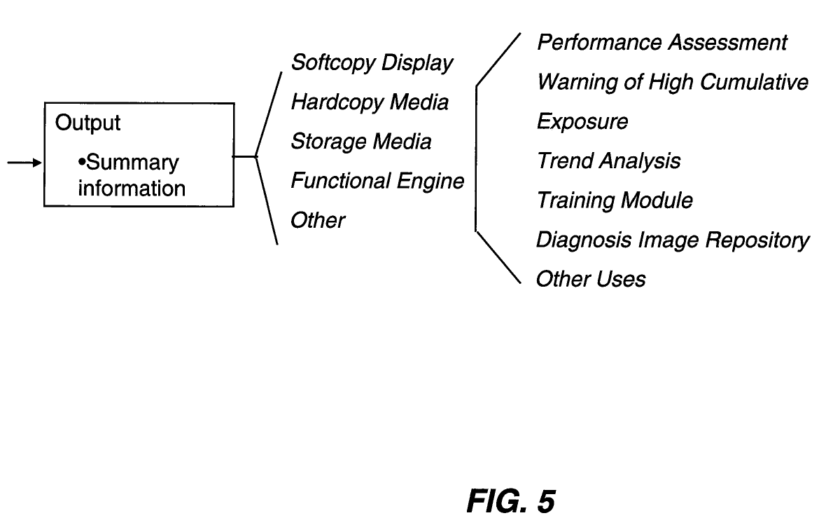

Still using the model system of FIG. 1, query engine 36 transforms information from user instruction engine 40 into SQL queries or other format queries to facilitate data processing or data mining. Alternately, query engine 36 may retrieve data from data mining database 18. It also generates summary information that may presented on a softcopy display, written to hardcopy, stored on storage media or used as input to another functional engine such as for image retrieval, and used for purposes that include performance assessment, alerting to some condition, trend analysis, training, and diagnosis. FIG. 5 is an illustration of some of the types and uses for output of query engine 36.

For example, a healthcare administrator may have a need to generate data on image quality, for benchmarking purposes, for all images collected over a six month period. The output in this case might be a table or chart presented to a display, sent to a printer, or written to a digital file; this chart can list body part, view position, and number of defective images, for example. In another application, a healthcare site may be very concerned about the exposure received by infants in the Neonatal Intensive Care Unit (NICU). The output in this case might be a warning sent to a monitoring display, a printer, or a file for infants who have reached a certain radiation exposure level. In another application, a healthcare administrator may wish to monitor technique practices over an extended time, even over a period of years. The output of query engine 36 could be directed to a digital file and stored, eventually to be used in a trend analysis. In another application, a healthcare site may wish to have a dedicated training station for technologists, radiologists, and clinicians. The output in this case might be a list or copy of images meeting a certain criteria that are placed on a digital storage device for viewing when studying a training module. In another case a radiologist may wish to identify images with certain CAD results. The output in this case might be a list of files or links to files, CAD results, or images written to a digital storage device.

### User Instruction Engine 40

Still using the model system of FIG. 1, user instruction engine 40 communicates to medical information system 10 the information desired and the form and type of output desired. User instruction engine 40 itself may use a graphical user interface, a digital file, or a voice sensitive system, for example. User instructions themselves can include directions for data processing engine 30, for data mining engine 32, and a listing of items to retrieve from data mining database 18. This may also include the type and format of output. User instructions may include ancillary instructions for use of the data, such as image retrieval or warning alert.

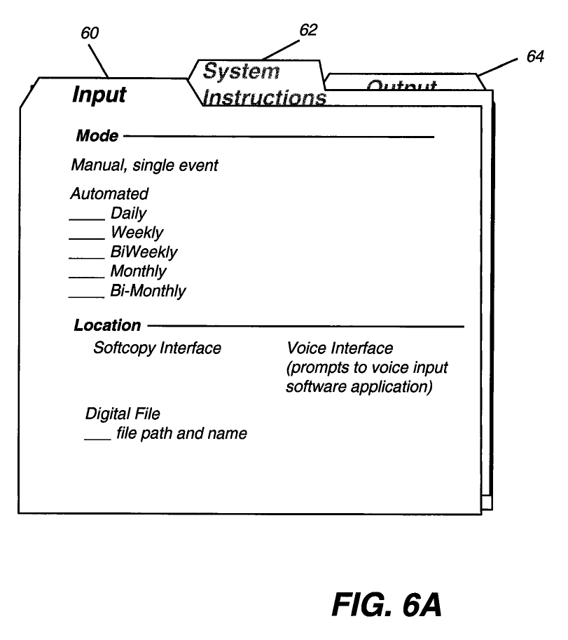

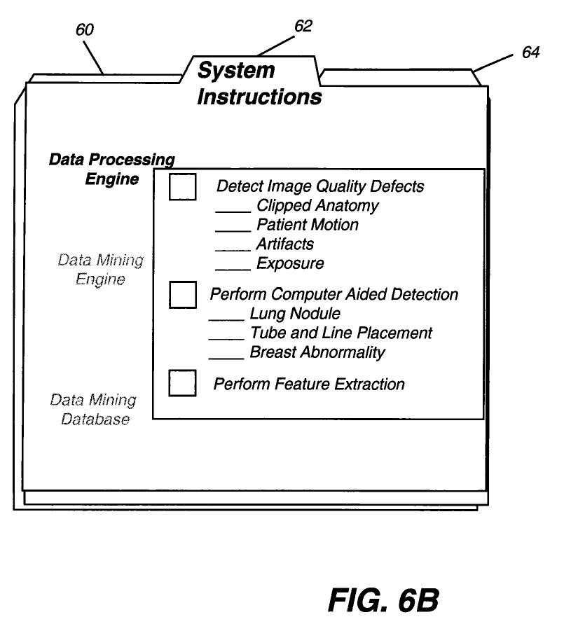

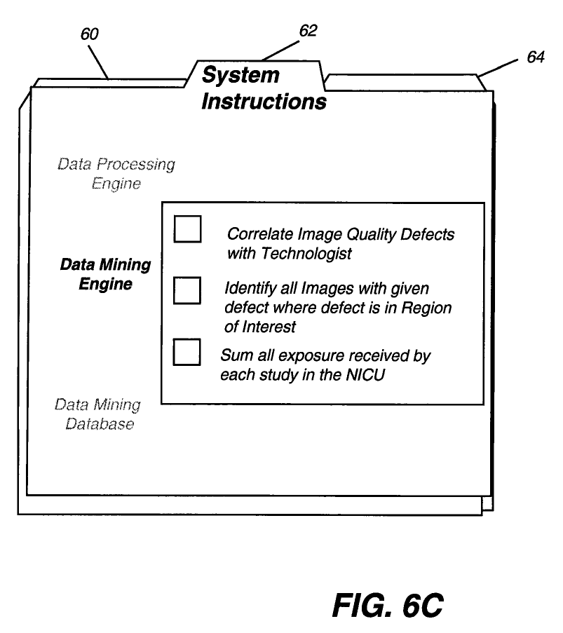

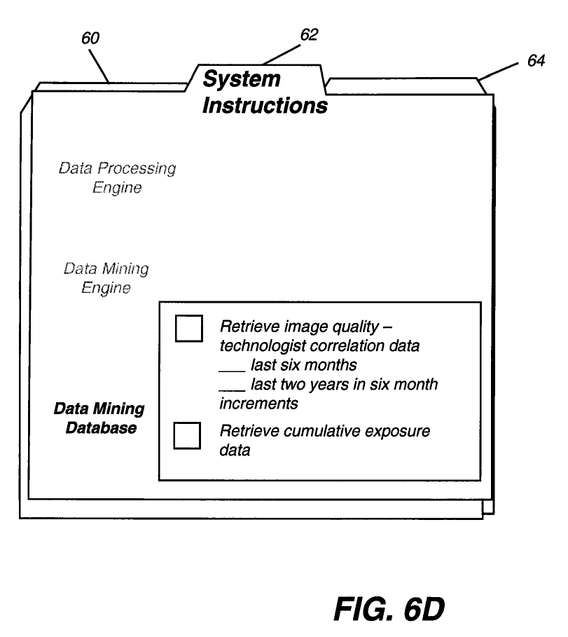

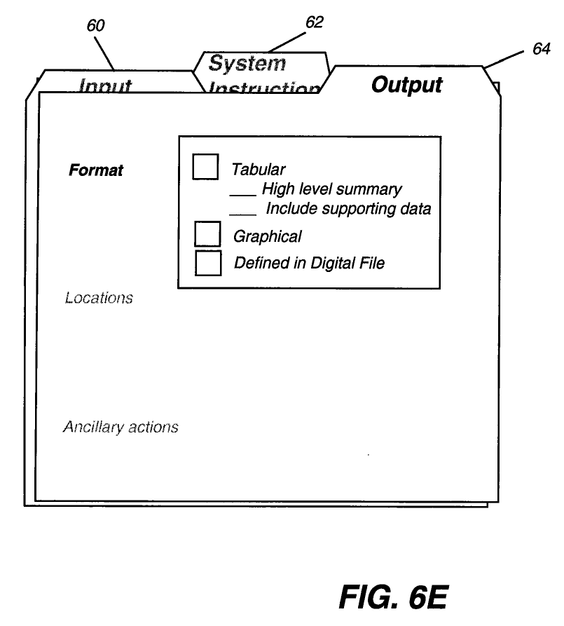

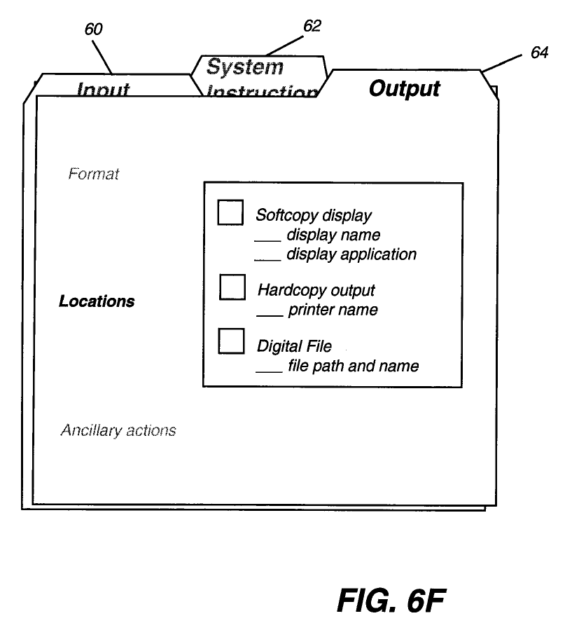

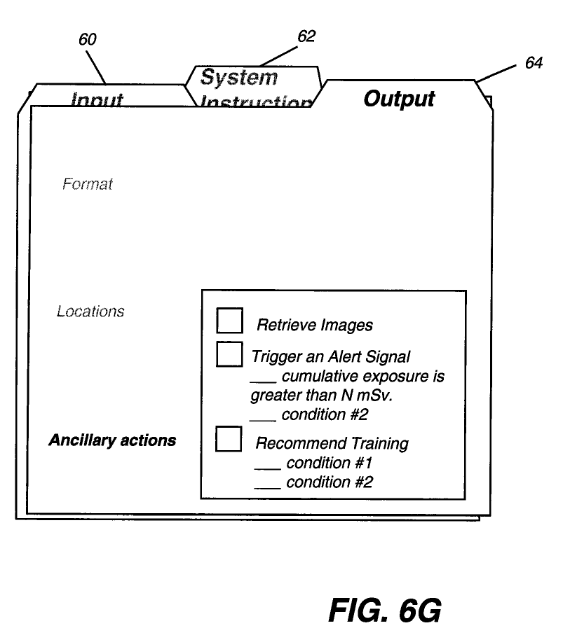

FIGS. 6A-6G illustrate the type of information that may be specified using a graphical user interface (GUI) of instruction engine 40, such as a display screen or touchscreen, for example. In the embodiment shown, the GUI has a tabular arrangement with an Input tab 60, a System Instructions tab 62, and an Output tab 64. Input tab 60 of FIG. 6A has entries for selecting a mode of operation, whether manually initiated or automated at some regular interval, and location of input data, such as a softcopy interface, digital file, or voice interface. for example. System Instructions tab 62 of FIGS. 6B, 6C, and 6D has entries for instructions relative to each of data processing engine 30, data mining engine 32, and data mining database 18. Instructions for data processing engine 30, for example, shown in FIG. 6B, utilize image analysis and Computer-Aided Detection (CAD) tools to obtain information from images of multiple patients for administrative or training functions. Instructions for data mining engine 32, shown in FIG. 6C, are then directed to correlation and summary information from images obtained. Instructions for data mining database 18, shown in FIG. 6D, retrieve stored data on image quality or imaging practices. Output tab 64 instructions, shown in FIGS. 6E, 6F, and 6G, are used to designate the format and locations for data that is obtained or to perform other actions, such as retrieving images or reporting results in various ways. Tabular or graphic output formats or file locations for example, may be selected for output formats. Ancillary actions may call other functional engines such as image retrieval for purposes such as diagnosis or training, triggering an alert, or training recommendations.

Unlike conventional data mining functions that are directed to obtaining information that is related to the condition, history, and treatment of an individual patient, medical information system 10 as shown in FIG. 1 and described herein is particularly well suited to the task of providing information that supports administration and delivery of health imaging services within a hospital or other medical facility. The apparatus and methods of the present invention read across multiple databases to obtain information from multiple patient records, where this information shows trends in how imaging services are provided. Image analysis functions are performed on selected images in order to obtain information that is relevant to the operation and effectiveness of a diagnostic imaging facility itself. Subsequent examples further illustrate use of medical information system 10 in particular embodiments.

### EXAMPLE 1

Administrators at a hospital are concerned with the amount of radiation that is used for chest imaging, with a goal to improving results obtained and eliminating radiation above a maximum threshold value. Periodic monitoring of these values is desired. To provide this information from data source 20 (FIG. 1), a technician using the system of the present invention makes the following GUI entries to user instruction engine 40:

### Input Tab 60 Selections (FIG. 6A):

### Mode:

### Automated, BiWeekly

### Location:

Softcopy interface

### System Instructions Tab 62 Selections:

### Data Processing Engine (FIG. 6B)

Exposure defects

### Data Mining Engine (FIG. 6C)

Sum all exposure received by each study

### Data Mining Database: (FIG. 6D)

Retrieve cumulative exposure data

### Output Tab 64 Selections:

Format: Tabular, High level summary (FIG. 6E)
Locations: Hardcopy output, xyzz printer (FIG. 6F)
Ancillary actions: (none) (FIG. 6G)

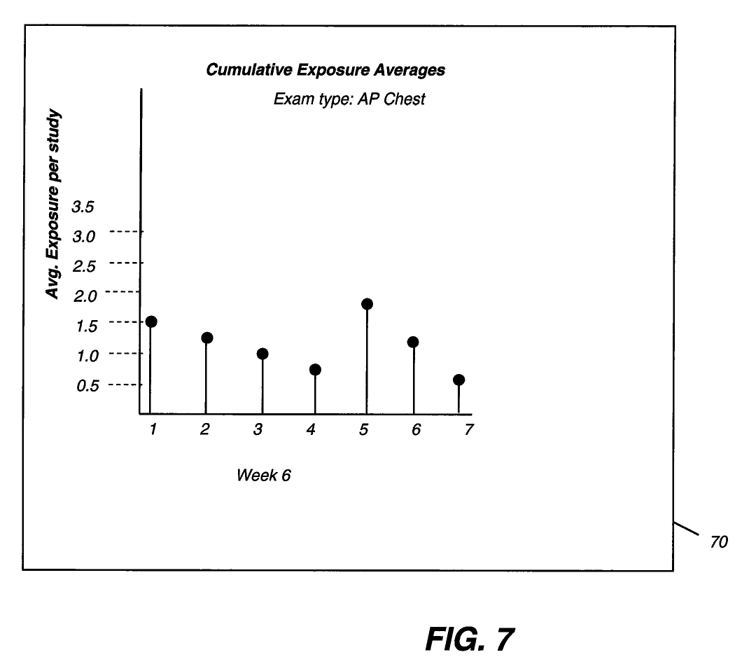

The technician then initiates the database search process, based on these entries. Data processing engine 30 of medical information system 10 (FIG. 1) then collects exposure data using utilities that calculate approximate exposure according to measured image data density. Methods for inferring exposure dose according to image data content are known to those skilled in the diagnostic imaging arts. FIG. 7 shows an example report 70 of cumulative exposure averages that is provided to the requesting user in one embodiment.

### EXAMPLE 2

Due to excessive image quality defects reported by diagnosticians, training is recognized as a management priority for imaging personnel in a large medical facility. It is desirable to consider results from each imaging technician in order to help identify strengths and weaknesses and recommend additional training for individual technicians.

### Input Tab 60 Selections: (FIG. 6A):

### Mode:

### Automated, BiWeekly

### Location:

Softcopy interface

### System Instructions Tab 62 Selections:

### Data Processing Engine (FIG. 6B)

Clipped anatomy

### Patient Motion

### Artifacts

Exposure defects

### Data Mining Engine (FIG. 6C)

Correlate image quality defects with technologist

### Data Mining Database: (FIG. 6D)

Retrieve cumulative image quality data

### Output Tab 64 Selections: (FIG. 6E)

### Format: Graphical

Locations: Hardcopy output, xyzz printer (FIG. 6F)
Ancillary actions: (FIG. 6G)
Recommend training (condition #1, #2, etc.)

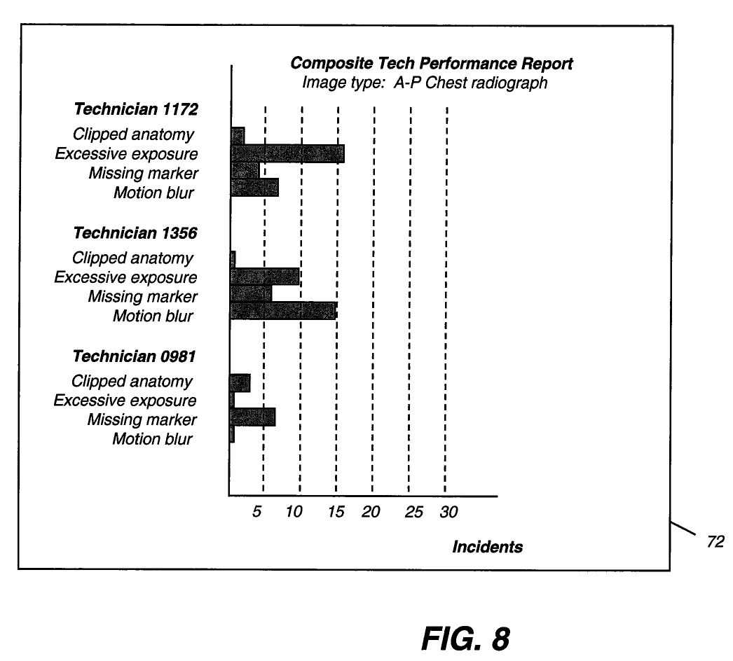

The technician then initiates the database search process, based on these entries. Data processing engine 30 of medical information system 10 (FIG. 1) then collects error data on image capture using utilities that detect problems such as clipped anatomy, motion blur, exposure problems, missing markers, tube placement, and similar problems in appropriately selected patient studies. FIG. 8 shows an example report 72 of technologist performance that is provided to the requesting user in one embodiment.

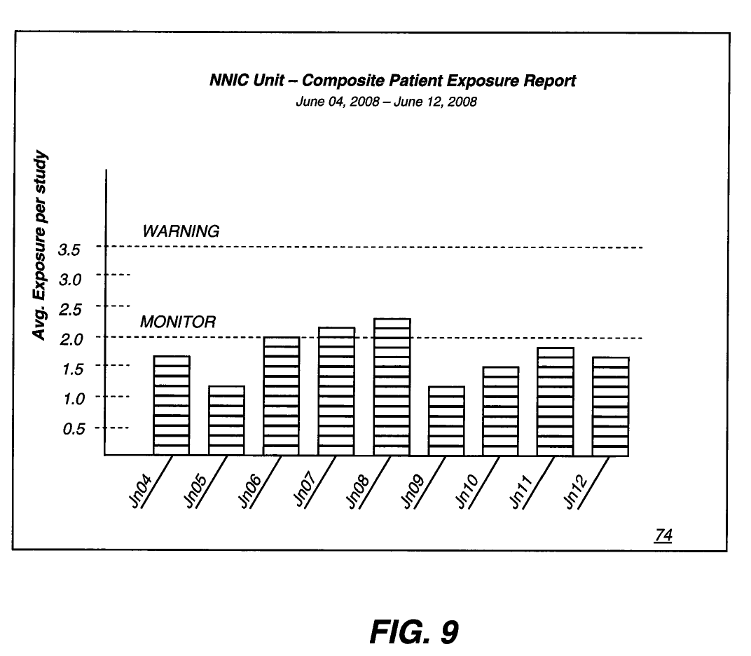

FIG. 9 shows another example output report 74 that gives data on patient exposure in a particular unit of the hospital. The displayed output in this example shows various levels of alert based on the data that is obtained and displayed.

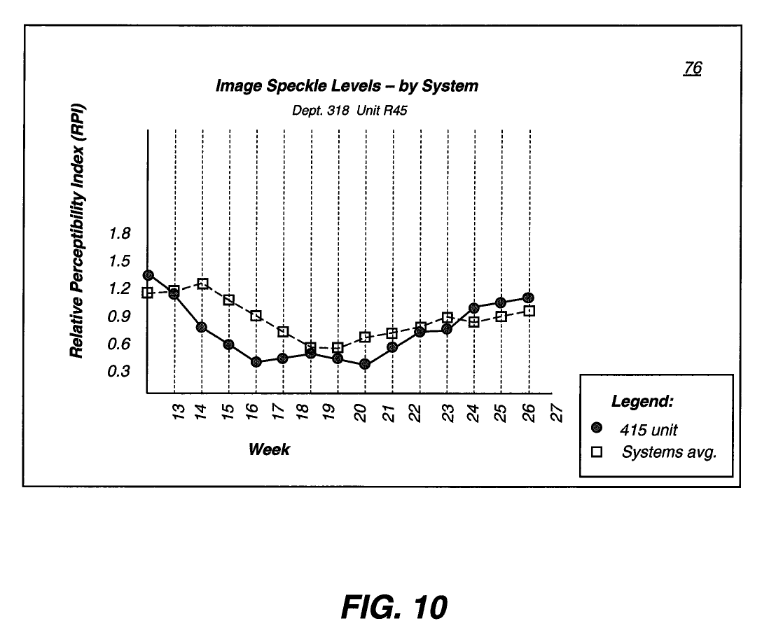

Methods of the present invention can also be used to monitor and track trends in equipment performance. FIG. 10 shows a graph in an output report 76 that is generated for displaying the perceptibility of image speckle per imaging system, with cumulative data displayed by the week. This type of information can be used to identify aging trends or to schedule maintenance or other service, for example. The system can also provide probability data related to image quality, including likelihood of proper detection of an image artifact, for example.

The invention has been described with reference to a subset of possible embodiments. However, it will be appreciated that variations and modifications can be effected by a person of ordinary skill in the art without departing from the scope of the invention. For example, various techniques could be employed for detecting image quality defects. GUI design can take any number of forms and the organization of elements for the user interface can be varied significantly from that shown in FIGS. 6A-6G in various embodiments.

Thus, what is provided is a system and method for obtaining information and knowledge relative to image quality obtained at an imaging site from image data that is stored in one or more medical image databases.

### PARTS LIST

10. Medical information system
18. Data mining database
20. Data source
22. PACS database
24. RIS database
26. HIS database
30. Data processing engine
32. Data mining engine
34. Processing database
36. Query engine
38. Module
40. User instruction engine
50. Source record
52. Patient identification field
54. Test field
58. Diagnosis field
60. Input tab
62. System Instructions tab
64. Output tab
70, 72, 74, 76. Report

1. A system for obtaining information related to diagnostic imaging performance at a site, the system comprising:
a user instruction interface for obtaining an operator request for information related to image quality for stored diagnostic images; and
a data processor in communication with at least one database of stored patient diagnostic images and programmed with instructions for retrieving one or more patient diagnostic images from the at least one database of patient diagnostic images according to the operator request from the user instruction interface, for analyzing the image quality of the one or more patient diagnostic images as specified in the operator request, and for providing at least output information about the image quality analysis to a data mining engine,
wherein the data mining engine is programmed with instructions to process the output information that is obtained from the data processor and to provide information related to image quality according to the output information.

2. The system of claim 1 wherein the instructions for retrieving one or more patient diagnostic images specify one or more of patient medical condition, image capture system identifier, patient age, and type of diagnostic image.

3. The system of claim 1 wherein the information related to image quality comprises information related to one or more of a clipped anatomy defect, motion blur, over-exposure, under-exposure, image speckle, and missing marker defect.

4. The system of claim 1 wherein information provided by the data mining engine relates to probability of an imaging artifact in the one or more retrieved patient diagnostic images.

5. The system of claim 1 wherein the instructions for retrieving one or more patient diagnostic images specify a particular imaging technologist.

6. The system of claim 1 wherein the instructions for retrieving one or more patient diagnostic images specify a particular imaging apparatus.

7. The system of claim 1 wherein the provided information related to image quality comprises information on the severity of a detected problem.

8. The system of claim 1 wherein the data processor comprises one or more modules for analyzing image data to identify one or more of the group of imaging artifacts consisting of motion blur, over-exposure, under-exposure, clipped anatomy, missing marker, and image speckle.

9. The system of claim 1 wherein the information related to image quality comprises information related to cumulative exposure and exposure-related trends during a period of time.

10. A method for obtaining information from a diagnostic image database comprising:
obtaining user instructions for information about image quality for images stored in the diagnostic image database;
directing a query for the image quality information to a data processing engine;
obtaining one or more patient images from the diagnostic image database related to the query;
analyzing the images obtained to provide an assessment of image quality;
providing the assessment of image quality to a data mining engine and correlating the assessment of image quality with one or more of a technician, an imaging apparatus, a patient condition, an image type, and a time interval; and
providing the correlation results as output information.

11. The method of claim 10 further comprising displaying the output information on a display monitor.

12. The method of claim 10 wherein the assessment of image quality comprises information about one or more of the group of imaging artifacts consisting of motion blur, over-exposure, under-exposure, clipped anatomy, missing marker, and image speckle.

13. The method of claim 10 wherein the output information further comprises warning information related to the assessment of image quality.

14. The method of claim 10 wherein obtaining one or more patient images comprises obtaining images from two or more patients according to the query.

15. A method for obtaining information related to performance of a diagnostic imaging facility comprising:
a) obtaining image quality criteria;
b) obtaining condition criteria that identifies one or more of patient pathology, image capture apparatus, time interval, technologist obtaining the image;
c) obtaining one or more images for each of a plurality of patients from a patient image database according to the condition criteria;
d) analyzing the one or more images obtained in c) according to the image quality criteria; and
e) reporting results of the analysis performed in d).

16. The method of claim 15 wherein the steps of obtaining image quality criteria comprise responding to instructions obtained from a user interface.

17. The method of claim 15 wherein the image quality criteria include one or more imaging artifacts taken from the group consisting of motion blur, over-exposure, under-exposure, clipped anatomy, missing marker, and image speckle.

18. The method of claim 15 wherein reporting results further comprises providing information on the severity of an image artifact.
